(19) United States
(12) Patent Application Publication
(10) Pub. No.: US 2025/0260509 A1
(43) Pub. Date: Aug. 14, 2025

(54) SYSTEMS AND METHODS OF FORWARD ERROR CORRECTION FOR CELLULAR COMMUNICATIONS

(71) Applicant: Meta Platforms Technologies, LLC, Menlo Park, CA (US)

(72) Inventors: Curt Wong, Bellevue, WA (US); Liwen Yu, Santa Clara, CA (US); Yousef Abdelmalek, New Providence, NJ (US); Zhu Ji, Cupertino, CA (US)

(73) Assignee: Meta Platforms Technologies, LLC, Menlo Park, CA (US)

(21) Appl. No.: 19/026,419

(22) Filed: Jan. 17, 2025

Related U.S. Application Data
(60) Provisional application No. 63/553,467, filed on Feb. 14, 2024.

(51) Int. Cl. H04L 1/00

(52) U.S. Cl. CPC H04L 1/0017; H04L 1/0042

(57) ABSTRACT

Systems and methods for forward error correction for cellular communication may include an endpoint which receives, from a wireless communication node, an indication of a portion of packets which are to be dropped by the wireless communication node, according to a first forward error correction (FEC) ratio. The endpoint may receive quality of service (QOS) feedback from another endpoint. The endpoint may determine whether to switch from the first FEC ratio to a second FEC ratio, according to the QoS feedback and the indication.

### CROSS-REFERENCE TO RELATED APPLICATIONS

This application claims the benefit of and priority to U.S. Provisional Application No. 63/553,467, filed Feb. 14, 2024, the contents of which are incorporated herein by reference in its entirety.

### FIELD OF DISCLOSURE

The present disclosure is generally related to wireless communication, including but not limited to, systems and methods for forward error correction for cellular communications.

### BACKGROUND

Augmented reality (AR), virtual reality (VR), and mixed reality (MR) are becoming more prevalent, which such technology being supported across a wider variety of platforms and device. Some AR/VR/MR devices may communicate with one or more other remote devices via a cellular connection.

### SUMMARY

In one aspect, this disclosure relates to a method. The method may include receiving, by a first wireless communication endpoint from a wireless communication node, an indication of a portion of packets which are to be dropped by the wireless communication node, according to a first forward error correction (FEC) ratio. The method may include receiving, by the first wireless communication endpoint, quality of service (QOS) feedback from a second wireless communication endpoint. The method may include determining, by the first wireless communication endpoint, whether to switch from the first FEC ratio to a second FEC ratio, according to the QoS feedback and the indication.

In some embodiments, the method further includes performing, by an encoder of the first wireless communication endpoint, a first forward error correction (FEC) of one or more first packets, according to the first FEC ratio, to generate one or more second packets. The method may further include transmitting, by the first wireless communication endpoint, the one or more first packets and the one or more second packets via the wireless communication node to the second wireless communication endpoint. In some embodiments, the QoS feedback from the second wireless communication endpoint is based on the one or more first packets and the one or more second packets. In some embodiments, the method further includes transmitting, by the first wireless communication endpoint to the wireless communication node, information corresponding to the first FEC ratio, the wireless communication node determining the portion of packets which are to be dropped based on the first FEC ratio.

In some embodiments, the method further includes determining, by the first wireless communication endpoint, modified QoS feedback, based on the QoS feedback from the second wireless communication endpoint and the indication. In some embodiments, the method further includes determining, by the first wireless communication endpoint, to switch to the second FEC ratio, responsive to the modified QoS feedback satisfying a switching criterion. The method may further include performing, by an encoder of the first wireless communication endpoint, a second FEC of one or more second packets, according to the second FEC ratio. In some embodiments, the first wireless communication endpoint includes a transmitter device, and the second wireless communication endpoint includes a receiver device.

In another aspect, this disclosure relates to a first wireless communication endpoint, including a transceiver and one or more processors configured to receive, via the transceiver from a wireless communication node, an indication of a portion of packets which are to be dropped by the wireless communication node, according to a first forward error correction (FEC) ratio. The one or more processors may be configured to receive, via the transceiver, quality of service (QOS) feedback from a second wireless communication endpoint. The one or more processors may be configured to determine whether to switch from the first FEC ratio to a second FEC ratio, according to the QoS feedback and the indication.

In some embodiments, the one or more processors are configured to perform, via an encoder of the first wireless communication endpoint, a first forward error correction (FEC) of one or more first packets, according to the first FEC ratio, to generate one or more second packets. The one or more processors may be configured to transmit, via the transceiver, the one or more first packets and the one or more second packets via the wireless communication node to the second wireless communication endpoint. In some embodiments, the QoS feedback from the second wireless communication endpoint is based on the one or more first packets and the one or more second packets. In some embodiments, the one or more processors are configured to transmit, via the transceiver to the wireless communication node, information corresponding to the first FEC ratio, the wireless communication node determining the portion of packets which are to be dropped based on the first FEC ratio.

In some embodiments, the one or more processors are configured to determine modified QoS feedback, based on the QoS feedback from the second wireless communication endpoint and the indication. In some embodiments, the one or more processors are configured to determine to switch to the second FEC ratio, responsive to the modified QoS feedback satisfying a switching criterion, and perform, via an encoder of the first wireless communication endpoint, a second FEC of one or more second packets, according to the second FEC ratio. In some embodiments, the first wireless communication endpoint includes a transmitter device, and wherein the second wireless communication endpoint includes a receiver device. In some embodiments, the receiver device includes at least one of a server, a user device, or a first peer device. In some embodiments, the wireless communication node from which the indication is received, includes a base station, and wherein the indication is received directly from the base station when the first wireless communication endpoint includes user equipment, and wherein the indication is received from the base station via a core network when the first wireless communication endpoint includes an application server.

In yet another aspect, this disclosure relates to a method including receiving, by a first wireless communication endpoint from a wireless communication node, an indication of a portion of packets which are to be dropped by the wireless communication node according to a first forward error correction (FEC) ratio received by the wireless communication node from a second wireless communication endpoint. The method may include determining, by the first wireless communication endpoint, quality of service (QOS) feedback for one or more packets transmitted by the second wireless communication endpoint and received via the wireless communication node, the QoS feedback determined based on the indication. The method may include transmitting, by the first wireless communication endpoint, the QoS feedback via the wireless communication node to the second wireless communication endpoint.

In some embodiments, the method further includes receiving, by the first wireless communication endpoint via the wireless communication node from the second wireless communication endpoint, the one or more packets with the first FEC ratio, wherein the first wireless communication endpoint determines the QOS feedback responsive to receiving the one or more packets. In some embodiments, the one or more packets include one or more first packets, and the method further includes receiving, by the first wireless communication endpoint via the wireless communication node from the second wireless communication endpoint, the one or more first packets with the first FEC ratio. The second wireless communication endpoint may update an FEC ratio, from the first FEC ratio to a second FEC ratio, based on the QoS feedback from the first wireless communication endpoint. The method may further include receiving, by the first wireless communication endpoint via the wireless communication node from the second wireless communication endpoint, the one or more second packets with the second FEC ratio. In some embodiments, the first wireless communication endpoint includes a receiver device, and the second wireless communication endpoint includes a transmitter device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system or forward error correction for cellular communications, according to an example implementation of the present disclosure.

FIG. 6 is a process flow for adaptive forward error correction for cellular communications, according to an example implementation of the present disclosure.

FIG. 7 is a flowchart showing an example method of forward error correction for cellular communications, according to an example implementation of the present disclosure.

FIG. 8 is a flowchart showing an example method for determining modified quality of service metrics for forward error correction in cellular communication, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

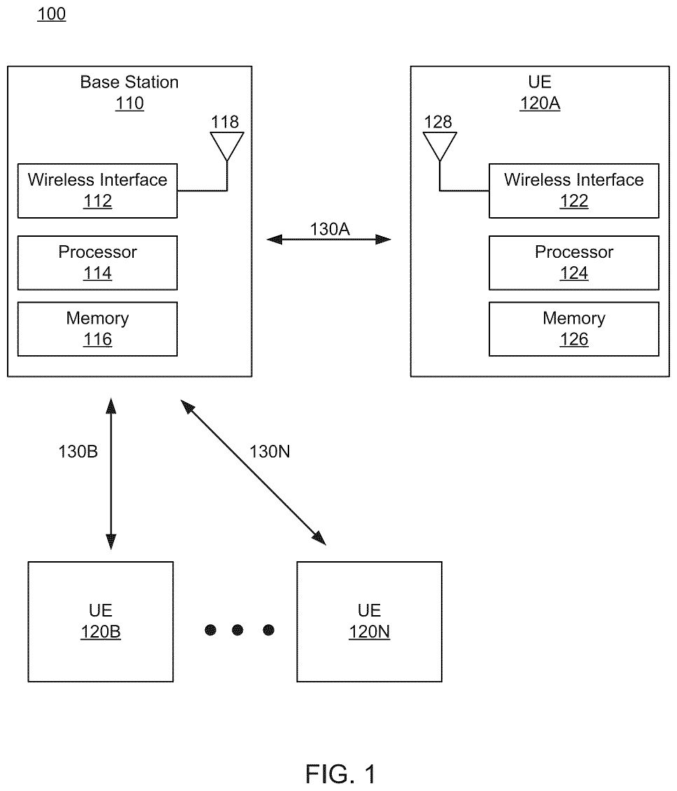

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHZ). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal.

The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and can provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

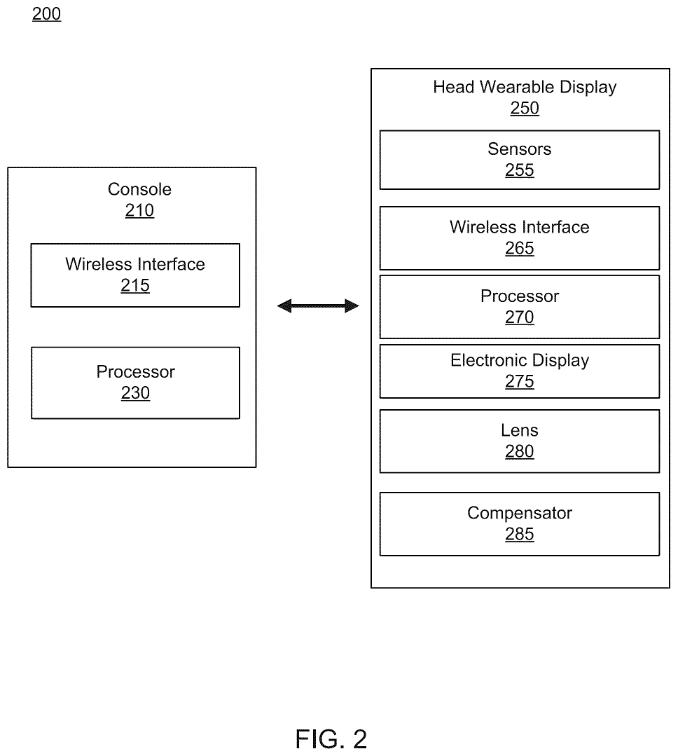

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and can determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and can capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and can append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

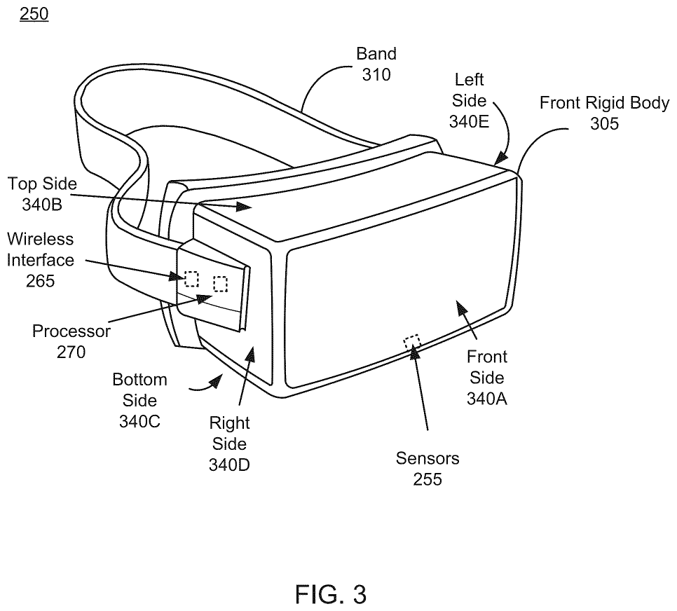

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

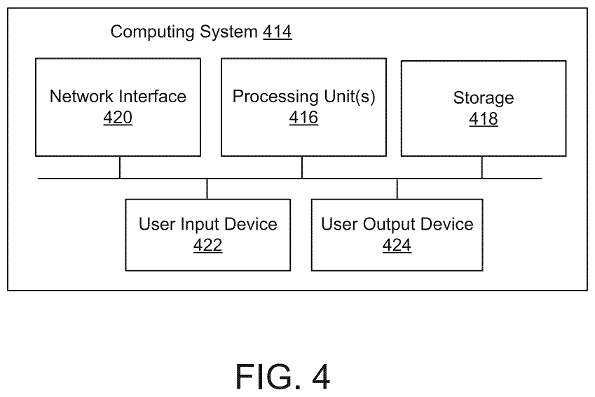

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

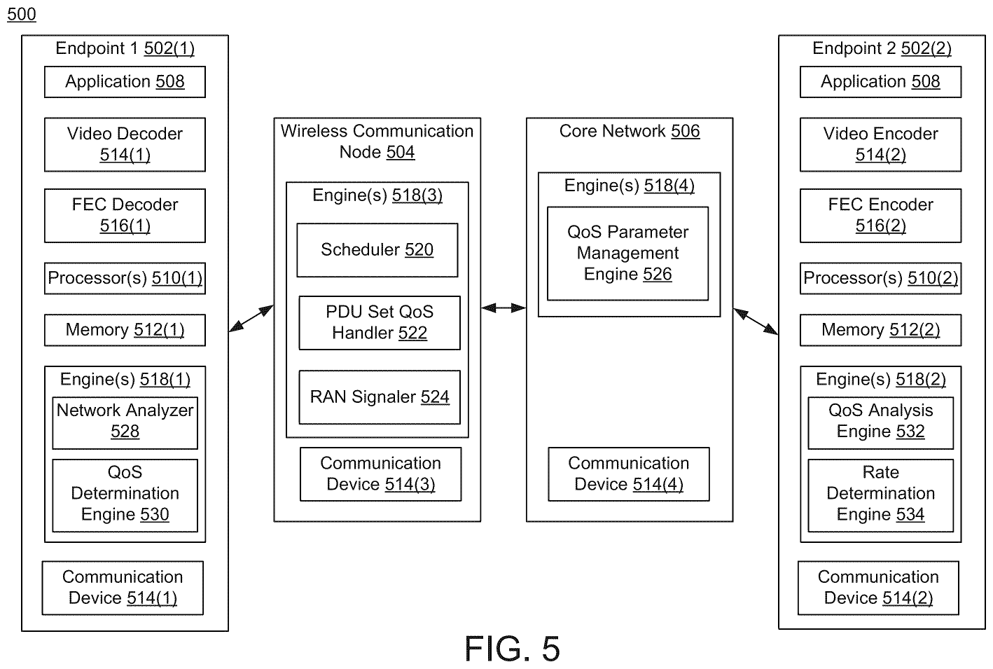

Referring generally to FIG. 5-FIG. 8, the systems and methods described herein may provide for forward error correction in cellular connections. For example, a user equipment (UE) may be configured to communicate with a server or other remote device via a cellular connection to a base station (BS) or wireless communication node. In certain implementations of the present solution, the systems and methods described herein may provide a radio access network (RAN)-aware forward error correction (FEC) feedback. In wireless cellular networks, a channel varies and a cell load changes over time. These changing conditions can be taken into consideration by an encoder when deciding on an appropriate FEC rate to use. By selecting the FEC rate based on the current network conditions, the systems and methods described herein may improve the performance of real-time communications (RTC) and provide a better user experience. In some implementations, a protocol data unit (PDU) set discard feature may be based on a whole PDU set during congestion. When PDU set contains both source and FEC packets, partial discard can be beneficial because, if a sufficient amount of PDUs of the PDU set is not discarded, then the receiver is still able to decode the frame.

Some implementations may cause a lack of RAN awareness to inform endpoints regarding the PDU set discard features. In view of this lack of awareness, the FEC coding rate may be unnecessarily changed due to those PDU set discard features. According to the systems and methods described herein, the FEC ratio may be sent via the user plane to the radio access network (RAN). The RAN may be configured to send back the discarded ratio and/or other related information (e.g., via the user plane) to the encoder, or to another endpoint, in which UE can incorporate this information as a feedback signal to sender via e.g., RTC-protocol (RTCP). Such solutions may provide for better quality of experience (QoE) for encoding in, e.g., extended reality (XR) implementations.

Referring to FIG. 5, depicted is a block diagram of a system 500 for forward error correction (FEC) for cellular communications, according to an example implementation of the present disclosure. The system 500 may include elements, hardware, or components similar to those described above with reference to FIG. 1-FIG. 4. For example, the system 500 may include one or more wireless communication endpoints 502 (generally referred to as endpoints 502, and transmitting endpoint 502(2) and receiving endpoint 502(1), respectively), a wireless communication node 504, and core network 506. The endpoints 502 may be similar to the user equipment 120, console 210, and/or head wearable display 250 described above with reference to FIG. 1-FIG. 4, and/or an application server which is hosting one or more resources/services/applications 508 executable by another endpoint 502. In other words, and in various embodiments, the endpoints 502 may be or include an application server and/or user equipment (e.g., in a peer-to-peer communication session and/or in communication with an application server). The system 500 may include a wireless communication node 504. The wireless communication node 504 may be, include, or be similar to the base station 110 described above with reference to FIG. 1. The system 500 may also include a core network 506, which may support, provide, or otherwise be associated with various wireless communication nodes (e.g., including the wireless communication node 504).

The endpoints 502 may include respective processor(s) 510, memory 512, communication device(s) 514. While processor(s) 510 and memory 512 are shown as included on the endpoints 502, it should be understood that the wireless communication node 504 and/or core network 506 may include similar hardware/components/elements. The processor(s) 510 may be the same as or similar to the processors 114, 124, 230, 270 and/or processing unit(s) 416 described above with reference to FIG. 1-FIG. 4. The memory 512 may be the same as or similar to memory 116, 126, and/or storage 418 described above with reference to FIG. 1-FIG. 4. The communication device 514 may be the same as or similar to the wireless interface 112, 122, 215, 265 (e.g., in combination with or communicably coupled to antenna 118, 128) and/or network interface 420 described above with reference to FIG. 1-FIG. 4.

The endpoints 502 may include respective encoders and decoders, which may include, respectively, video and FEC encoders 514(1), 516(1), and video and FEC decoders 514(2), 516(2). It should be understood that, while the encoders 514(2), 516(2) are shown as being included on the second endpoint 502(2) (e.g., which is a transmitting endpoint 502(2)) and the decoders 514(1), 516(1) are shown as being included on the first endpoint 502(1) (e.g., which is a receiving endpoint 502(1)) for instances in which the transmitting endpoint 502(2) is transmitting encoded data to the receiving endpoint 502(1), in various embodiments, the first endpoint 502(1) may similarly include encoders 514(2), 516(2), and the second endpoint 502(2) may include decoders 514(1), 516(1), for instances in which the first endpoint 502(1) is transmitting encoded data to the second endpoint 502(2).

As described in greater detail below, a transmitting endpoint 502 may be configured to encode packet(s) at a first ratio or rate (e.g., a first FEC ratio) via the FEC encoder 516(2), for transmission to the receiving endpoint 502. The transmitting endpoint 502 may be configured to transmit information relating to the first ratio (e.g., via the core network 506) to the wireless communication node 504. The wireless communication node 504 may be configured to use the first ratio to selectively discard certain packet(s) (e.g., of the encoded packet(s)), so as to avoid unnecessarily transmitting all of the packet(s) to the receiving endpoint 502 (e.g., particularly in instances of congestion at the wireless communication node 504). The wireless communication node 504 may be configured to transmit an indication of the discarded packet(s) to the transmitting endpoint 502 and/or receiving endpoint 502. In instances where the receiving endpoint 502 receives the indication from the wireless communication node 504, the receiving endpoint 502 may be configured to use information included in the indication to determine QoS feedback (e.g., informed by the indication) for transmission to the transmitting endpoint. In instances where the transmitting endpoint 502 receives the indication from the wireless communication node 504 (e.g., together with the receiving endpoint or instead of the indication being received by the receiving endpoint), the transmitting endpoint 502 may be configured to determine or otherwise identify modified QoS feedback (e.g., modified relative to the QoS feedback received from the transmitting endpoint 502 based on the indication and/or modified by the transmitting endpoint 502 based on the indication). The transmitting endpoint 502 may be configured to selectively update the first ratio based on or according to the modified QoS feedback, to thereby adaptively configure the FEC ratio according to the modified QoS feedback.

The endpoints 502, wireless communication node 504, and core network 506 may include various processing engine(s) 518. The processing engine(s) 518 may be or include any device, component, element, or hardware designed or configured to perform one or more of the functions described herein. While certain processing engine(s) 518 are shown and described herein, it should be understood that additional and/or alternative processing engine(s) 518 may be implemented on the endpoints 502, wireless communication node 504, and/or core network 506. Additionally, two or more of the processing engine(s) 518 may be implemented as a single processing engine 518. Furthermore, one of the processing engine(s) 518 may implemented as multiple processing engines 518.

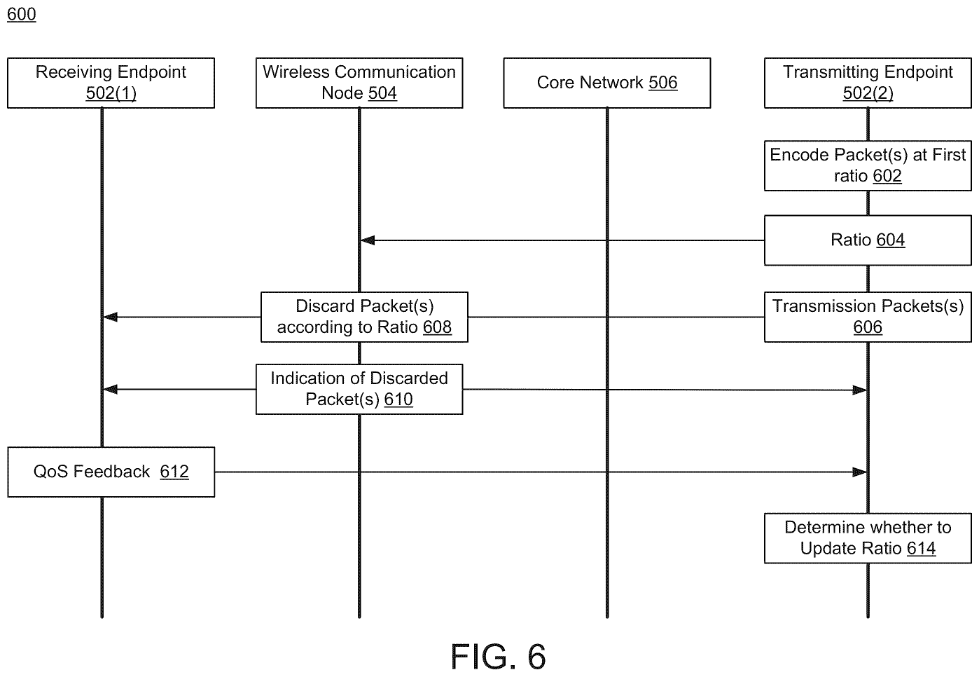

Referring now to FIG. 6, and with continued reference to FIG. 5, depicted is a process flow 600 for adaptive forward error correction (FEC) for cellular communications, according to an example implementation of the present disclosure. The process flow 600 may be executed by the hardware, components, or elements introduced above in FIG. 5, and described in greater detail below.

At process 602, the transmitting endpoint 502(2) may be configured to encode one or more first packet(s) according to a first ratio. In various embodiments, the transmitting endpoint 502(2) may be configured to generate a first set of packets responsive to execution of the application 508. For example, the application 508 may be or include an extended reality (XR) application, such as but not limited to a voice, video, or avatar-based call/conferencing application, a gaming application, a virtual reality or augmented reality application, etc. The application 508 may include or involve generation of video data (e.g., raw video data) for transmission to the receiving endpoint 502(1) at various time instances, responsive to execution of the application 508. For example, the application 508 may generate video data based on captured video frames from one or more camera(s) of the endpoint 502(2), based on stored and/or rendered video content, etc.

As shown in FIG. 5, the transmitting endpoint 502(2) may include a video encoder 514(2) and a FEC encoder 516(2). The video encoder 514(2) may be configured to generate, configure, establish, derive, or otherwise encode the video data into a format for transmission to the receiving endpoint 502(1). For example, the video encoder 514(2) may be configured to apply compression to the video data (e.g., using a video codec, such as H.264, H.265, AV1, etc.), to generate encoded video packets.

The FEC encoder 516(2) may be configured to generate, configure, or otherwise provide one or more FEC packets (e.g., redundant packets, FEC parity packets, etc.) using the encoded video packets from the video encoder 514(2). In various embodiments, the FEC encoder 516 may be configured to generate the FEC packet(s) by applying/adding redundancy to the encoded video packets. For example, the FEC encoder 516 may be configured to encode the video packets from the video encoder 514(2), with additional parity or redundant packets, based on an FEC scheme, such as Reed-Solomon or LDPC (Low-Density Parity-Check). The FEC encoder 516 may be configured to generate the one or more FEC packets according to a FEC ratio. The FEC ratio may be or include a ratio or proportion of FEC packets added by the FEC encoder 516(2) to the encoded video packets generated by the video encoder 514(2). Correspondingly, a higher FEC ratio may increase error-correction capability (e.g., by the receiving endpoint 502(1), but may utilize more network bandwidth and resources for transmission of the transmission packets (e.g., the combination of FEC packets and encoded video packets). As described in greater detail below, the FEC encoder 516(2) may be configured to dynamically adjust the FEC ratio based on or according to modified QoS feedback from the receiving endpoint 502(1) (based on an indication received from the wireless communication node 504).

At process 604, the transmitting endpoint 502(2) may be configured to transmit, communicate, send, or otherwise signal the FEC ratio (e.g., via the core network 506) to the wireless communication node 504. In some embodiments, the transmitting endpoint 502(2) may be configured to transmit the FEC ratio together with transmitting the transmission packets (e.g., at process 606) to the wireless communication node 504 for transmission to the receiving endpoint 502(1). For example, the transmitting endpoint 502(2) may be configured to incorporate the FEC ratio in metadata of the packets, such as in a packet header or other information element. In some embodiments, the transmitting endpoint 502(2) may be configured to signal the FEC ratio separately from the transmission of the transmission packet(s) at process 606. For example, the transmitting endpoint 502(2) may be configured to signal the FEC ratio in a control message or information element, such as a radio resource control (RRC) signaling, MAC signaling, or other form of information element.

At process 606, the wireless communication node 504 may be configured to selectively discard various packets (or protocol data units PDUs), based various QoS metrics and the FEC ratio signaled by the transmitting endpoint 502(2).

As shown in FIG. 5, the wireless communication node 504 may include a scheduler 520 and a PDU set QoS handler 522. The scheduler 520 may be configured to manage the scheduling of transmission and delivery of packets to the receiving endpoint 502(1). In some embodiments, the scheduler 520 may be configured to allocate resources for transmission/delivery of packets, based on available bandwidth, priority levels, and/or current network conditions. For example, the scheduler 520 may be configured to prioritize packets associated with latency-sensitive applications, such as XR or video conferencing.

The PDU set QoS handler 522 may be configured to selectively discard packets of the transmission packets or PDU sets (e.g., transmitted at process 606). The PDU set QoS handler 522 may be configured to discard one or more of the packet(s), based on the FEC ratio signaled by the transmitting endpoint 502(2) and one or more QoS metrics. In some embodiments, the core network 506 may include a QoS parameter management engine 526 configured to manage, provision, or otherwise signal QoS metrics associated with one or more PDU sessions. Such QoS metrics may include, but not limited to, latency, packet error rate, packet drop rate, available bandwidth, resource consumption, and/or priority level, relating to the network conditions. The QoS parameter management engine 526 may be configured to signal the QoS metrics to the wireless communication node 504. The PDU set QoS handler 522 may be configured to use the QoS metrics, to evaluate network conditions and make decisions regarding packet retention or discarding within the PDU set. For instance, the PDU set QoS handler 522 may be configured to discard packets under conditions of network congestion, where the number of discarded packets may correspond to the FEC ratio, thereby alleviating network load while retaining sufficient parity packets to enable error recovery. As another example, the PDU set QoS handler 522 may be configured to retain all packets when network congestion is absent, thereby maximizing data fidelity. The scheduler 520 may be configured to schedule transmission and delivery of the PDU sets (e.g., following selective discarding of one or more of the transmission packets by the PDU set QoS handler 522) to the receiving endpoint 502.

At process 610, a RAN signaler 524 may be configured to indicate, transmit, send, signal, communicate, or otherwise provide an indication of the discarded packets of the transmission packets. In some embodiments, the indication may include or otherwise identify a portion of packets which are to be dropped by the wireless communication node 504. For example, the indication may identify a discard portion, rate, ratio, which the PDU set QoS handler 522 determined according to the QoS metrics and the FEC ratio. The RAN signaler 524 may be configured to signal the indication to the transmitting endpoint 502(2), the receiving endpoint 502(1), and/or both the transmitting and receiving endpoints 502(1), 502(2). The RAN signaler 524 may be configured to signal the indication in various signaling formats and via various plane signaling. For example, the RAN signaler 524 may be configured to signal the indication via control plane signaling (e.g., in one or more RRC signaling messages), via data plane signaling (e.g., in a PDU header or other protocol header), via a dedicated or custom information element or signaling messages (e.g., MAC signaling or other higher-layer protocol signaling).

In some embodiments, the indication may include additional information relating to the QoS metrics. For example, the RAN signaler 524 may be configured to signal various QoS metrics to the transmitting endpoint 502(2) and/or receiving endpoint 502(1), such as but not limited to wireless network conditions, cell load, channel condition, congestion information, QoS indicators, and so forth. In some embodiments, the indication may include the FEC ratio provided by the transmitting endpoint 502(2) to the wireless communication node 504 (e.g., at process 604).

At process 612, the receiving endpoint 502(1) may be configured to determine, identify, or otherwise generate QoS feedback for transmission to the transmitting endpoint 502(2). As shown in FIG. 5, the receiving endpoint 502(1) may include a network analyzer 528 and QoS determination engine 530. The network analyzer 528 may be configured to identify, detect, or otherwise determine one or more network conditions relating to delivery of packets/PDUs from the wireless communication node 504 to the receiving endpoint 502(1). For example, the network analyzer 528 may be configured to detect, identify, or otherwise determine one or more network conditions relevant to the delivery of the transmission packets (e.g., transmitted at process 606 by the transmitting endpoint 502(2) from the wireless communication node 504 to the receiving endpoint 502(1). The network conditions may include various QoS metrics such as, but not limited to, packet delay, jitter, packet loss rates, and throughput. In some embodiments, the network analyzer 528 may be configured to process QoS metrics received from the wireless communication node 504 (e.g., the RAN signaler 524) to update, modify, or otherwise refine the network conditions identified by the network analyzer 528. For example, the network analyzer 528 may be configured to use the QoS metrics from the RAN signaler 524 to determine trends in packet delivery reliability or identify periods of congestion that impact PDU delivery.

The QoS determination engine 530 may be configured to generate QoS feedback for transmission to the transmitting endpoint 502(2). The QoS feedback may be based at least in part on the network conditions determined by the network analyzer 528. In some embodiments (such as where the RAN signaler 524 provides the indication to the receiving endpoint 502(1)), the QoS determination engine 530 may be configured to determine modified QoS feedback based on the indication received from the wireless communication node 504. For example, the QoS determination engine 530 may be configured to determine the modified QoS feedback based on the discard ratio signaled in the indication from the RAN signaler 524. In some embodiments, the QoS determination engine 530 may be configured to evaluate the relationship between the discard ratio and the FEC ratio, to determine an impact of the network conditions to the reliability of the packets being delivered by the wireless communication node 504. For instance, if the discard ratio is less than or equal to the FEC ratio, the QoS feedback may indicate that the current level of redundancy is sufficient to handle the observed network conditions.

In some implementations, the QoS determination engine 530 may be configured to package the network conditions and other relevant information into a structured feedback format, suitable for dynamic adaptation (e.g., of the FEC ratio) by the transmitting endpoint 502(2). For example, the feedback may specify that increased redundancy or reduced video quality is to be used to address high packet loss rates, or may indicate no adjustments may be used if the network conditions are stable and the discard ratio is within acceptable limits. The QoS determination engine 530 may be configured to transmit, communicate, send, or otherwise provide the QoS feedback via the wireless communication node 504 and core network 506 to the transmitting endpoint 502(2).

At process 614, the transmitting endpoint 502(2) may be configured to determine whether to update the FEC ratio. As shown in FIG. 5, the transmitting endpoint 502(2) may include a QoS analysis engine 532 and a rate determination engine 534. As described in greater detail below, the QoS analysis engine 532 may be configured to determine or otherwise identify modified QoS feedback, based on the QoS feedback from the transmitting endpoint 502. The rate determination engine 534 may be configured to use the modified QoS feedback to determine whether or not to modify the FEC ratio (e.g., used to encode the first packet(s) at process 602), based on the modified QoS feedback.

The QoS analysis engine 532 may be configured to determine or otherwise identify modified QoS feedback based on the QoS feedback transmitted by the receiving endpoint 502(1) and, optionally, the indication transmitted by the wireless communication node 504. For example, where the wireless communication node 504 provides the indication (e.g., a discard ratio) to the transmitting endpoint 502(2) but not the receiving endpoint 502(1), the QoS analysis engine 532 may be configured to calculate, derive, or otherwise determine the modified QoS feedback using the discard ratio in a manner similar to the QoS determination engine 530 described above. In scenarios where the wireless communication node 504 provides the indication to the receiving endpoint 502(1) such that the QoS determination engine 530 generates the modified QoS feedback based at least in part on the indication, the QoS analysis engine 532 may identify the modified QoS feedback as the QoS feedback received from the receiving endpoint 502(1) (e.g., transmitted at process 612).

The QoS analysis engine 532 may be configured to analyze specific QoS metrics and network conditions from the QoS feedback, to determine or otherwise identify relevant QoS parameters for the rate determination engine 534. Such QoS parameters may include, for example, packet loss rate, jitter, latency, throughput, and congestion indicators. The QoS analysis engine 532 may be configured to analyze the relationship between the QoS parameters and the discard ratio signaled by the wireless communication node 504. For instance, the QoS analysis engine 532 may be configured to use a high discard ratio in combination with increased packet loss rates and latency to indicate potential network congestion, requiring adjustment of the FEC ratio. Conversely, stable latency and low discard rates may indicate that the current FEC ratio is sufficient to maintain acceptable quality.

The rate determination engine 534 may be configured to determine whether to update, modify, or otherwise switch from the FEC ratio (e.g., used at process 602) to a different FEC ratio, based at least in part on the modified QoS feedback. For example, and in some embodiments, the rate determination engine 534 may be configured to compare the FEC ratio with the discard ratio and/or other QoS metrics, to determine whether or not to increase/decrease/maintain a ratio of redundancy packets to encoded video packets. In some embodiments, the rate determination engine 534 may be configured to apply the FEC ratio and discard ratio and/or other QoS metrics to switching criteria or criterion, to determine whether or not to switch to a different FEC ratio. For example, if the FEC ratio is less than the discard ratio, the rate determination engine 534 may be configured to determine to increase the FEC ratio to provide additional redundancy and improve error correction. As another example, if the FEC ratio exceeds the discard ratio, the rate determination engine 534 may be configured to maintain the FEC ratio (or reduce the FEC ratio to optimize bandwidth usage, where the discard ratio is less than the FEC ratio by a defined relative threshold).

In some embodiments, if the discard ratio indicates minimal packet loss or congestion, the rate determination engine 534 may be configured to maintain the current FEC ratio or signal a reduction in the FEC ratio to the FEC encoder 516(2). In some embodiment, if the discard ratio exceeds a threshold relative to the FEC ratio and is coupled with adverse QoS metrics (e.g., high latency or packet loss), the rate determination engine 534 may signal an increase in the FEC ratio to the FEC encoder 516(2). The rate determination engine 534 may be configured to signal the change in the FEC encoder 516(2), which may correspondingly use the updated FEC ratio to generate redundancy packets for subsequent encoded video packets (e.g., from the video encoder 514(2)), according to the updated FEC ratio.

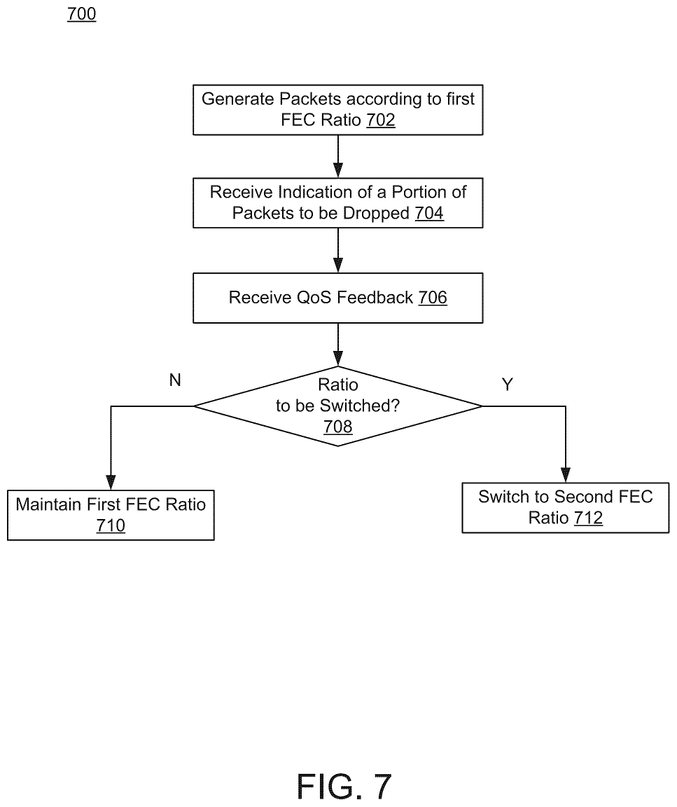

Referring now to FIG. 7, depicted is a flowchart showing an example method 700 of forward error correction for cellular communications, according to an example implementation of the present disclosure. The method 700 may be performed, executed, or otherwise implemented by the hardware, components, or elements described above with reference to FIG. 1-FIG. 6. In some embodiments, the method 700 may be executed by transmitting endpoint 502(2) (e.g., including the components thereof). As a brief overview, at step 702, the transmitting endpoint may generate packets according to a first FEC ratio. At step 704, the transmitting endpoint may receive an indication of a portion of packets to be dropped. At step 706, the transmitting endpoint may receive QoS feedback. At step 708, the transmitting endpoint may determine whether the FEC ratio is to be switched. At step 710, the transmitting endpoint may maintain the first FEC ratio. At step 712, the transmitting endpoint may switch to a second FEC ratio.

At step 702, the transmitting endpoint may generate packets according to a first FEC ratio. In some embodiments, the transmitting endpoint may generate a first set of packets by, via, or using a video encoder of the transmitting endpoint. The transmitting endpoint may generate the first set of packets responsive to execution of an application at the transmitting endpoint or a device communicably coupled to/paired with the transmitting endpoint. For example, the application may be an extended reality (XR) application, such as a voice, video, or avatar-based call/conferencing application, a gaming application, or a virtual reality or augmented reality application. The application may produce raw video data, which the video encoder may encodes into compressed video data, forming the first set of packets for transmission.

The transmitting endpoint may generate a second set of packets based on or according to the first FEC ratio. Specifically, the transmitting endpoint may generate the second set of packets by performing a first forward error correction (FEC) encoding of the first set of packets using an FEC encoder, according to the first FEC ratio. The FEC encoder may generate redundant packets, or FEC packets, parity packets, etc., to the encoded video packets from the video encoder. The FEC ratio may define the proportion/ratio of the FEC packets to the encoded video packets. In other words, the number of encoded video packets may define the number of FEC packets generated by the FEC encoder, according to the first FEC ratio.

The transmitting endpoint may transmit the first packets and the second packets (e.g., as transmission packets including the first and second packet(s)) via a wireless communication node to a second wireless communication endpoint (e.g., the receiving endpoint). In some embodiments, the transmitting endpoint may transmit information corresponding to the first FEC ratio to the wireless communication node. For example, the transmitting endpoint may include the first FEC ratio in packet headers, metadata, or information elements (IEs) to the wireless communication node. As another example, the transmitting endpoint may send the FEC ratio to the wireless communication node through dedicated signaling messages. The wireless communication node may utilize the FEC ratio to determine the portion of packets that are to be dropped, as described below.

At step 704, the transmitting endpoint may receive an indication of a portion of packets to be dropped. In some embodiments, the transmitting endpoint may receive the indication from the wireless communication node. The indication may indicate a portion of packets which are to be dropped by the wireless communication node, according to the first FEC ratio (e.g., used to generate the packets at step 702). In some embodiments, the indication may include, at least, a discard ratio which indicates the portion of packets which are to be dropped by the wireless communication node). The discard ratio may indicate, define, or otherwise identify the proportion of packets to be dropped by the wireless communication node relative to the total number of transmission packets. In some embodiments, the wireless communication node may determine the discard ratio based on network conditions, such as congestion levels, bandwidth availability, or the priority of other data flows being handled by the node. In some embodiments, the wireless communication node may apply the discard ratio uniformly across the first set of packets (encoded video packets) and the second set of packets (FEC packets). In some embodiments, the wireless communication node may apply the discard ratio by dropping specific types of packets, such as initially dropping the FEC packets, to optimize resource usage.

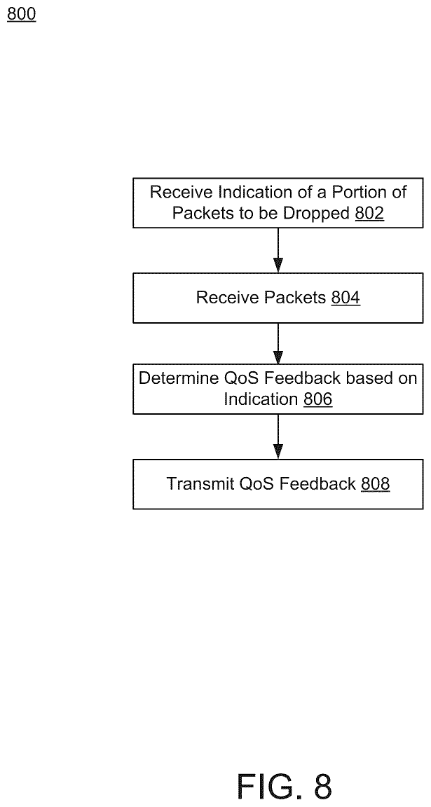

In some embodiments, the wireless communication node may transmit, and the transmitting endpoint may correspondingly receive, the indication through one or more signaling mechanisms. For example, the transmitting endpoint may receive the indication via control plane signaling, such as an RRC message. As another example, the transmitting endpoint may receive the indication via or within metadata or headers associated with user plane packets. In some embodiments, the wireless communication node may transmit the indication to both the transmitting endpoint and the receiving endpoint. In implementations in which the wireless communication node transmits the indication to the receiving endpoint, the receiving endpoint may determine modified QoS feedback, as described in FIG. 8 below.

At step 706, the transmitting endpoint may receive QoS feedback. In some embodiments, the transmitting endpoint may receive the QoS feedback from the second wireless communication endpoint. In some embodiments, the QOS feedback from the second wireless communication endpoint may be based on the one or more first packets and the one or more second packets. Additional details regarding the QoS feedback is described in greater detail below with reference to FIG. 8.

In some embodiments, the transmitting endpoint may determine modified QoS feedback, based on the QoS feedback received at step 706. For example, the transmitting endpoint may determine the modified QoS feedback based on the QoS feedback received at step 706 and the indication received at step 704. For example, where at step 704, the indication which is received from the wireless communication node is not also provided to the receiving endpoint, the transmitting endpoint may determine the modified QoS feedback based on the indication. The modified QoS feedback may reflect an integrated assessment of network conditions and the packet management behavior of the wireless communication node, as indicated by the discard ratio or other information corresponding to the portion of packets received at step 704. For example, where the indication received at step 704 from the wireless communication node is not also provided to the receiving endpoint, the transmitting endpoint may determine the modified QoS feedback by supplementing the QoS feedback received at step 706 with the discard ratio or other parameters relating to the discarded portion of packets identified in the indication. The transmitting endpoint may use the discard ratio to estimate an effective packet loss rate, incorporating both network-induced losses and intentional discards by the wireless communication node according to the FEC ratio.

In some embodiments, the transmitting endpoint may also analyze specific QoS metrics from the feedback received at step 706, such as latency, jitter, and throughput, in conjunction with the discard ratio, to determine the modified QoS feedback. For example, if the QoS feedback indicates minimal latency and jitter but the discard ratio is high, the transmitting endpoint may attribute packet losses primarily to intentional discards by the wireless communication node, rather than adverse network conditions. In such cases, the modified QoS feedback may reflect positive QoS irrespective of the discard ratio. Conversely, if the QoS feedback indicates high latency, jitter, or packet loss rates combined with a high discard ratio, the transmitting endpoint may determine that the network is experiencing both congestion and quality degradation. In such cases, the modified QoS feedback may indicate network congestion and negative QoS.

At step 708, the transmitting endpoint may determine whether the FEC ratio is to be switched. In some embodiments, the transmitting endpoint may determine whether the FEC ratio is to be switched, according to the QoS feedback and the indication. For example, the transmitting endpoint may determine whether the ratio is to be switched, based on the effective packet loss rate in the modified QoS feedback satisfying a switching criterion. Where, at step 708, the transmitting endpoint determines not to switch the FEC ratio, the method 700 may proceed to step 710. Where, at step 708, the transmitting endpoint determines to switch the FEC ratio, the method 700 may proceed to step 712.

At step 710, the transmitting endpoint may determine to maintain the first FEC ratio. The transmitting endpoint may determine to maintain the first FEC ratio, where the modified QoS feedback does not satisfy a switching criterion. For instance, if the modified QoS feedback indicates that the, e.g., effective discard ratio is within a threshold relative to the FEC ratio, the transmitting endpoint may elect to maintain the FEC ratio. For example, where the effective discard ratio is less than the FEC ratio (e.g., within a certain threshold of the FEC ratio), the transmitting endpoint may determine to maintain the first FEC ratio. In this example, the transmitting endpoint may perform a second forward error correction (FEC) operation on a subsequent set of packets using the first FEC ratio. The second FEC operation may result in generation of a redundant set of packets based on the subsequent set of packets, such that the relative number or ratio of redundant packets (e.g., FEC packets) to the subsequent set of packets (e.g., encoded video packets) remains consistent with the ratio applied at step 702.

At step 712, the transmitting endpoint may determine to switch to a second FEC ratio. The transmitting endpoint may determine to switch from the first FEC ratio to a second FEC ratio, in response to the modified QoS feedback satisfying the switching criterion. For instance, the transmitting endpoint may determine to switch from the first FEC ratio to the second FEC ratio, based on the effective discard ratio relative to the FEC ratio and/or based on other network conditions. For example, the modified QoS feedback may indicate adverse network conditions, such as an increased discard ratio or a combination of high latency and effective packet loss rates, such that the current FEC ratio may be insufficient to ensure reliable communication. In this example, the transmitting endpoint may determine to switch from the first FEC ratio to a second FEC ratio greater than the first FEC ratio (e.g., to generate additional redundant FEC packets). As another example, the modified QoS feedback may indicate that the effective discard ratio is less than the FEC ratio by a certain threshold, thereby indicating that the FEC ratio is excessive given the current network conditions. In this example, the transmitting endpoint may determine to switch from the first FEC ratio to a second FEC ratio less than the first FEC ratio (e.g., to generate fewer redundant FEC packets). In either of these examples, the transmitting endpoint may perform a second FEC operation on a subsequent set of packets using the second FEC ratio. The new ratio results in a different relative number or proportion of redundant packets to the subsequent set of packets compared to the ratio applied at step 702.

Referring now to FIG. 8, depicted is a flowchart showing an example method 800 for determining modified quality of service metrics for forward error correction in cellular communication, according to an example implementation of the present disclosure. The method 800 may be performed, executed, or implemented on the hardware, components, or elements described above with reference to FIG. 1-FIG. 6. For example, and in some embodiments, the method 800 may be performed by the receiving endpoint 502(1). As a brief overview, at step 802, the receiving endpoint may receive an indication of a portion of packets to be dropped. At step 804, the receiving endpoint may receive the packets. At step 806, the receiving endpoint may determine QoS feedback based on the indication. At step 808, the receiving endpoint may transmit the QoS feedback.

At step 802, the receiving endpoint may receive an indication of a portion of packets to be dropped. In some embodiments, the receiving endpoint may receive the indication from a wireless communication node. The indication may indicate, identify, or otherwise signal a portion of packets which are to be dropped by the wireless communication node according to a first forward error correction (FEC) ratio received by the wireless communication node from a second wireless communication endpoint. The indication may be similar to the indication received at step 704 described above.

At step 804, the receiving endpoint may receive the packet(s) from the wireless communication node and transmitted by the transmitting endpoint. In some instances, the packets received at step 804 may include the same or fewer packets than the transmission packets sent by transmitting endpoint (e.g., the same where the wireless communication node does not discard any portion of the transmission packets, or fewer where the wireless communication node discards a portion of the transmission packets).

In some embodiments, the receiving endpoint may receive the indication (e.g., at step 802) from the wireless communication node together with receiving the packets at step 804. For example, the wireless communication node may include the indication within the same transmission as the packets, such as embedding the indication in packet headers, metadata, and/or within a control field associated with the transmitted packets. In some embodiments, the receiving endpoint may receive the indication from the wireless communication node in a separate signaling with respect to receipt of the packets. For instance, the wireless communication node may transmit the indication via a control plane message, such as an RRC signaling message or an independent signaling frame delivered on a dedicated channel.

At step 806, the receiving endpoint may determine QoS feedback based on the indication. In some embodiments, the receiving endpoint may determine QoS feedback for the packets transmitted by the transmitting endpoint and received (e.g., at step 804) via the wireless communication node. The receiving endpoint may determine the QoS feedback based on the indication received at step 802. In some embodiments, the receiving endpoint may determine the QoS feedback based on the packet(s) received at step 804, and responsive to receipt of the packets. The QoS feedback may reflect, indicate, identify, or otherwise provide various metrics or conditions related to network conditions and/or the received packets, such as packet loss rates, latency, jitter, and throughput.

In response, the receiving endpoint may determine the QoS feedback based on the actual packets received at step 804 and in response to their receipt. For instance, the receiving endpoint may analyze the sequence numbers of the received packets to identify gaps or out-of-order delivery. The receiving endpoint may determine the QoS feedback based on the indication received at step 803, to distinguish between losses caused by intentional discards and those arising from adverse network conditions. For example, if the discard ratio indicates a high portion of FEC parity packets being dropped while the received packet loss is minimal, receiving endpoint may generate QoS feedback that indicates/reflects stable network conditions with effective error correction. Conversely, if packet loss or latency exceeds expected thresholds given the discard ratio, the QoS feedback may highlight potential issues with congestion or insufficient redundancy.

At step 808, the receiving endpoint may transmit the QoS feedback. In some embodiments, the receiving endpoint may transmit the QoS feedback via the wireless communication node to the second wireless communication endpoint. The QoS feedback may be transmitted through one or more signaling mechanisms, such as, for example, the receiving endpoint embedding/incorporating the QoS feedback in control plane signaling messages, such as RRC signaling or MAC layer messages, transmitting the QoS feedback in a dedicated user plane message, using metadata or application-layer signaling protocols, and so forth.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by a first wireless communication endpoint from a wireless communication node, an indication of a portion of packets which are to be dropped by the wireless communication node, according to a first forward error correction (FEC) ratio;
receiving, by the first wireless communication endpoint, quality of service (QOS) feedback from a second wireless communication endpoint; and
determining, by the first wireless communication endpoint, whether to switch from the first FEC ratio to a second FEC ratio, according to the QoS feedback and the indication.

2. The method of claim 1, further comprising:
performing, by an encoder of the first wireless communication endpoint, a first forward error correction (FEC) of one or more first packets, according to the first FEC ratio, to generate one or more second packets; and
transmitting, by the first wireless communication endpoint, the one or more first packets and the one or more second packets via the wireless communication node to the second wireless communication endpoint.

3. The method of claim 2, wherein the QoS feedback from the second wireless communication endpoint is based on the one or more first packets and the one or more second packets.

4. The method of claim 1, further comprising:
transmitting, by the first wireless communication endpoint to the wireless communication node, information corresponding to the first FEC ratio, the wireless communication node determining the portion of packets which are to be dropped based on the first FEC ratio.

5. The method of claim 1, further comprising:
determining, by the first wireless communication endpoint, modified QoS feedback, based on the QoS feedback from the second wireless communication endpoint and the indication.

6. The method of claim 5, wherein further comprising:
determining, by the first wireless communication endpoint, to switch to the second FEC ratio, responsive to the modified QoS feedback satisfying a switching criterion; and
performing, by an encoder of the first wireless communication endpoint, a second FEC on one or more second packets, according to the second FEC ratio, to generate one or more third packets.

7. The method of claim 1, wherein the first wireless communication endpoint comprises a transmitter device, and the second wireless communication endpoint comprises a receiver device.

8. A first wireless communication endpoint, comprising:
a transceiver; and
one or more processors configured to:
receive, via the transceiver from a wireless communication node, an indication of a portion of packets which are to be dropped by the wireless communication node, according to a first forward error correction (FEC) ratio;
receive, via the transceiver, quality of service (QOS) feedback from a second wireless communication endpoint; and
determine whether to switch from the first FEC ratio to a second FEC ratio, according to the QoS feedback and the indication.

9. The first wireless communication endpoint of claim 8, wherein the one or more processors are configured to:
perform, via an encoder of the first wireless communication endpoint, a first forward error correction (FEC) of one or more first packets, according to the first FEC ratio, to generate one or more second packets; and
transmit, via the transceiver, the one or more first packets and the one or more second packets via the wireless communication node to the second wireless communication endpoint.

10. The first wireless communication endpoint of claim 9, wherein the QoS feedback from the second wireless communication endpoint is based on the one or more first packets and the one or more second packets.

11. The first wireless communication endpoint of claim 8, wherein the one or more processors are configured to:
transmit, via the transceiver to the wireless communication node, information corresponding to the first FEC ratio, the wireless communication node determining the portion of packets which are to be dropped based on the first FEC ratio.

12. The first wireless communication endpoint of claim 8, wherein the one or more processors are configured to:
determine modified QoS feedback, based on the QoS feedback from the second wireless communication endpoint and the indication.

13. The first wireless communication endpoint of claim 12, wherein the one or more processors are configured to:
determine to switch to the second FEC ratio, responsive to the modified QoS feedback satisfying a switching criterion; and
perform, via an encoder of the first wireless communication endpoint, a second FEC of one or more second packets, according to the second FEC ratio.

14. The first wireless communication endpoint of claim 8, wherein the first wireless communication endpoint comprises a transmitter device, and wherein the second wireless communication endpoint comprises a receiver device.

15. The first wireless communication endpoint of claim 14, wherein the receiver device comprises at least one of a server, a user device, or a first peer device.

16. The first wireless communication endpoint of claim 8, wherein the wireless communication node from which the indication is received, comprises a base station, and wherein the indication is received directly from the base station when the first wireless communication endpoint comprises user equipment, and wherein the indication is received from the base station via a core network when the first wireless communication endpoint comprises an application server.

17. A method comprising:
receiving, by a first wireless communication endpoint from a wireless communication node, an indication of a portion of packets which are to be dropped by the wireless communication node according to a first forward error correction (FEC) ratio received by the wireless communication node from a second wireless communication endpoint;
determining, by the first wireless communication endpoint, quality of service (QOS) feedback for one or more packets transmitted by the second wireless communication endpoint and received via the wireless communication node, the QoS feedback determined based on the indication; and
transmitting, by the first wireless communication endpoint, the QoS feedback via the wireless communication node to the second wireless communication endpoint.

18. The method of claim 17, further comprising:
receiving, by the first wireless communication endpoint via the wireless communication node from the second wireless communication endpoint, the one or more packets with the first FEC ratio,
wherein the first wireless communication endpoint determines the QoS feedback responsive to receiving the one or more packets.

19. The method of claim 17, wherein the one or more packets comprise one or more first packets, the method further comprising:
receiving, by the first wireless communication endpoint via the wireless communication node from the second wireless communication endpoint, the one or more first packets with the first FEC ratio, wherein the second wireless communication endpoint updates an FEC ratio, from the first FEC ratio to a second FEC ratio, based on the QoS feedback from the first wireless communication endpoint; and
receiving, by the first wireless communication endpoint via the wireless communication node from the second wireless communication endpoint, the one or more second packets with the second FEC ratio.

20. The method of claim 17, wherein the first wireless communication endpoint comprises a receiver device, and the second wireless communication endpoint comprises a transmitter device.
